(19) United States
(12) Patent Application Publication
(10) Pub. No.: US 2008/0192253 A1
(43) Pub. Date: Aug. 14, 2008

(54) METHOD AND TEST-STRUCTURE FOR DETERMINING AN OFFSET BETWEEN LITHOGRAPHIC MASKS

(76) Inventors: Susie Xiuru Yang, Sunnyvale, CA (US); Michael C. Smayling, Fremont, CA (US)

Correspondence Address: APPLIED MATERIALS/BLAKELY, 1279 OAKMEAD PARKWAY, SUNNYVALE, CA, 94085-4040, US

(21) Appl. No.: 11/672,781

(22) Filed: Feb. 8, 2007

(51) Int. Cl. G01B 11/00; G03C 5/00

(52) U.S. Cl. 356/401; 430/327

(57) ABSTRACT

A method and a test-structure for determining an offset between lithographic masks are described. In one embodiment, an image of a first mask is provided in a patterning layer on a substrate. The image of the first mask comprises a first set of lines, each line separated by a distance D. An image of a second mask is then provided in the patterning layer. The image of the second mask comprises a second set of lines, each line also separated by the distance D. The second set of lines interlays the first set of lines to form a grating with a distance L between each of the lines of the first set of lines and the respective corresponding lines of the second set of lines. The offset between the first and second masks is determined by calculating the difference between the distance L and a predetermined value K, where 0<K<D. In a specific embodiment, K=½D.

### BACKGROUND OF THE INVENTION

1) Field of the Invention

The invention is in the fields of Lithography and Semiconductor Processing.

2) Description of Related Art

For the past several decades, the scaling of features in integrated circuits has been the driving force behind an ever-growing semiconductor industry. Scaling to smaller and smaller features enables increased densities of functional units on the limited real estate of semiconductor chips. For example, shrinking transistor size allows for the incorporation of an increased number of logic and memory devices on a microprocessor, lending to the fabrication of products with increased complexity.

Scaling has not been without consequence, however. As the dimensions of the fundamental building blocks of microelectronic circuitry are reduced and as the sheer number of fundamental building blocks fabricated in a given region is increased, the constraints on the lithographic processes used to pattern these building blocks have become overwhelming. In particular, exacting mask alignment in multi-exposure or multi-layer processes is often required. The smaller the features and the higher the feature density for a given patterning step, the more critical it is to have an alignment method that achieves both accuracy and precision when aligning the pattern from one mask with the pattern from another mask. Two such methods used to date are the Vernier method of mask alignment and the box-in-box method of mask alignment.

FIG. 1 illustrates a Vernier method of mask alignment, in accordance with the prior art. A substrate 102 has a first set of lines 104 from a first mask and a second set of lines 106 from a second mask patterned thereon. The spacing between lines in the first set of lines 104 is greater than the spacing between lines in the second set of lines 106. If the first and second mask were perfectly aligned, central lines 105 and 107 would be aligned. However, when central lines 105 and 107 are not aligned, the extent of mask misalignment may be determined by establishing which line from the first set of lines 104 is actually aligned with a corresponding line from the second set of lines 106. For example, referring to FIG. 1, each of the first lines to the left of central lines 105 and 107, respectively, are aligned with one another. The offset between the first and the second mask may be calculated based on how many lines are counted until a pair of lines is truly aligned and then calibrating that count by the differential in spacing distances between the lines within each set of lines 104 and 106. One drawback to the Vernier approach, however, is that the method to determine which lines are actually aligned is usually based on human judgment and is susceptible to error.

FIG. 2 illustrates a box-in-box method of mask alignment, in accordance with the prior art. A substrate 202 has a first box 204 from a first mask and a second box 206 from a second mask patterned thereon. The second box 206 is smaller than the first box 204. The offset between the first and second masks can be determined in both the X-direction and in the Y-direction by comparing the location of the second box 206 with a set of calibration coordinates 208. For example, referring to FIG. 2, the second box 206, and hence the second mask, is misaligned from the first box 204, and hence the first mask, by a shift to the right in the X-direction and an upward shift in the Y-direction. One drawback to the box-in-box approach, however, is that more than one patterning layer must be used in order to produce the image of a small box inside of a larger box.

Thus, a method and a test-structure for determining an offset between lithographic masks are described herein.

### BRIEF DESCRIPTION OF THE DRAWINGS

FIG. 1 illustrates a Vernier method of mask alignment, in accordance with the prior art.

FIG. 2 illustrates a box-in-box method of mask alignment, in accordance with the prior art.

FIG. 3 illustrates a grating method of mask alignment, in accordance with an embodiment of the present invention.

FIG. 4 illustrates the cross-sectional representation of a negative exposure process for enabling a grating method of mask alignment, in accordance with an embodiment of the present invention.

FIG. 5 illustrates the cross-sectional representation of a positive exposure process for enabling a grating method of mask alignment, in accordance with an embodiment of the present invention.

FIG. 6 illustrates a system for carrying out a grating method of mask alignment, in accordance with an embodiment of the present invention.

FIG. 7 illustrates a plot of Grating Offset versus Goodness of Fit (GOF) of offset gratings compared with a calibration grating, in accordance with an embodiment of the present invention.

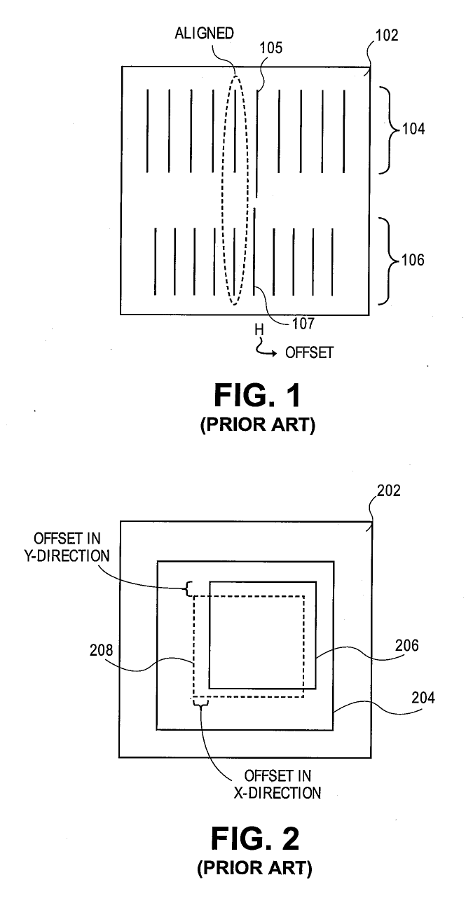

### DETAILED DESCRIPTION

A method and a test-structure for determining an offset between lithographic masks are described. In the following description, numerous specific details are set forth, such as operating conditions and material regimes, in order to provide a thorough understanding of the present invention. It will be apparent to one skilled in the art that the present invention may be practiced without these specific details. In other instances, well-known features, such as integrated circuit design layouts or wet chemical developing processes, are not described in detail in order to not unnecessarily obscure the present invention. Furthermore, it is to be understood that the various embodiments shown in the figures are illustrative representations and are not necessarily drawn to scale.

Disclosed herein are a method and a test-structure for determining an offset between a first mask and a second mask. An image of a first mask may be provided in a patterning layer on a substrate, wherein the image comprises a first set of lines, each line separated by a distance D. In one embodiment, an image of a second mask is then provided in the patterning layer. The image of the second mask comprises a second set of lines, each line also separated by the distance D. The second set of lines interlays the first set of lines to form a grating with a distance L between each of the lines of the first set of lines and the respective corresponding lines of the second set of lines. The offset between the first and second masks is determined by calculating the difference between the distance L and a predetermined value K, where 0<K<D. In another embodiment, prior to providing the second image, a photo-resist layer is deposited over the patterning layer having the image of the first mask patterned therein. An image of the second mask is then provided in the photo-resist layer and the offset between the first and second masks is determined.

By forming a grating comprised of two sets of lines, each with a fixed spacing D, a spectral determination may be used to determine the offset between two masks. For example, in accordance with an embodiment of the present invention, an image of a grating having a first set of lines interlaid with a second set of lines is formed in a patterning layer. The patterning layer is developed to form an actual grating and a scatterometric measurement is made by inputting a light signal into the grating and collecting the signal as scattered by the grating. The collected signal is compared with a calibration signal collected from a calibration grating. The calibration grating is set to a value that represents mask alignment (i.e. 0 offset), while the offset between the two masks is determined by measuring the deviation of the signal detected from the grating with that of the calibration signal. In a processing scheme requiring mask alignment, future exposures may be corrected by adjusting the masks based on the measured offset. In a specific embodiment, the calibration grating is included on one of the masks undergoing the alignment (offset) determination.

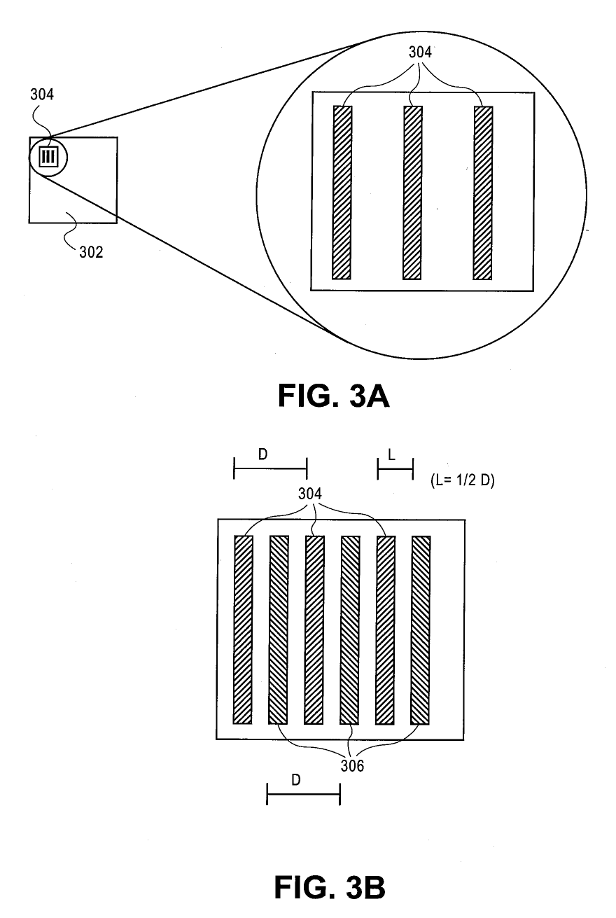

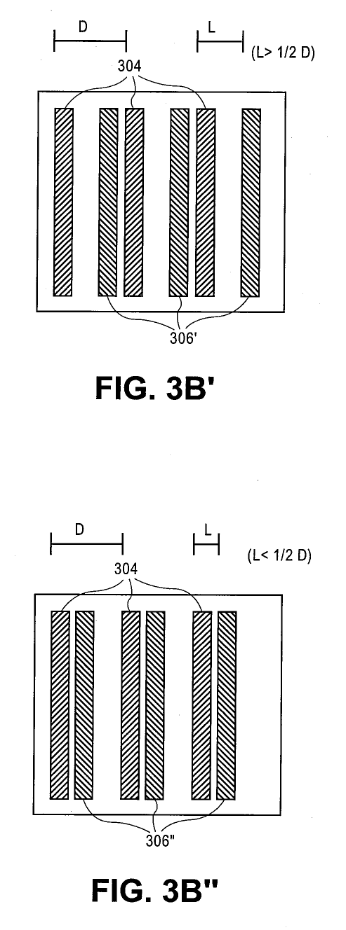

The offset between two lithographic masks may be determined by first forming and then calibrating a grating. FIG. 3 illustrates a grating method of mask alignment, in accordance with an embodiment of the present invention.

Referring to FIG. 3A, an image of a first mask is provided on a substrate 302. The image of the first mask is comprised of a first set of lines 304. Referring to FIG. 3B, an image of a second mask is subsequently provided on substrate 302. The image of the second mask is comprised of a second set of lines 306. Each of the lines in the first set of lines 304 is separated by a distance D, as are each of the lines in the second set of lines 306. The second set of lines 306 interlays the first set of lines 304 to form a grating with a distance L between each of the lines of the first set of lines 304 and the respective corresponding lines of the second set of lines 306.

Substrate 302 may be comprised of any material suitable to withstand a lithographic process. In an embodiment, substrate 302 is comprised of a flexible plastic sheet. Substrate 302 may further be comprised of a material suitable to withstand a manufacturing process and upon which semiconductor layers may suitably reside. In an embodiment, substrate 302 is comprised of group IV-based materials such as crystalline silicon, germanium or silicon/germanium. In another embodiment, substrate 302 is comprised of a III-V material. Substrate 302 may also comprise an insulating layer. In one embodiment, the insulating layer is comprised of a material selected from the group consisting of silicon dioxide, silicon nitride, silicon oxy-nitride and a high-k dielectric layer.

The first set of lines 304 may be housed directly in substrate 302 or in a layer disposed on substrate 302. In an embodiment, the first set of lines 304 is housed in an etch film above substrate 302. In one embodiment, the etch film is comprised of a robust organic polymer, such as poly-imide. In one embodiment, the etch film is comprised of a dielectric material selected from the group consisting of carbon-doped oxide, silicon oxide, silicon oxy-nitride, silicon nitride and a high-k dielectric material. In one embodiment, the etch film is comprised of a semiconductor film selected from the group consisting of amorphous silicon, poly-crystalline silicon, epitaxial silicon and silicon/germanium. In another embodiment, the first set of lines 304 is housed in a photo-resist layer above substrate 302. In one embodiment, the photo-resist layer is comprised of a negative photo-resist layer selected from the group consisting of poly-cis-isoprene and poly-vinyl-cinnamate. In one embodiment, the photo-resist layer is comprised of a positive photo-resist layer selected from the group consisting of a 248 nm resist, a 193 nm resist, a 157 nm resist and a phenolic resin matrix with a diazonaphthoquinone sensitizer. The layer used to house the first set of lines 304 may be used to form a portion of a physical grating based on the first set of lines 304. Thus, in accordance with an embodiment of the present invention, the layer used to house the first set of lines has a thickness sufficient to scatter a signal from a scatterometer. In one embodiment, the layer used to house the first set of lines has a thickness of at least 10 nanometers.

The second set of lines 306 may also be housed directly in substrate 302 or in a layer disposed on substrate 302, but need not be housed in the same layer as the first set of lines 304. In one embodiment, both the first set of lines 304 and the second set of lines 306 are housed in substrate 302. In one embodiment, the first set of lines 304 is housed in substrate 302 and the second set of lines 306 is housed in a layer disposed on substrate 302, wherein the layer is comprised of a material described in association with layers that may house the first set of lines 304. In one embodiment, both the first set of lines 304 and the second set of lines 306 are housed in the same layer disposed on substrate 302. In one embodiment, the first set of lines 304 is housed in a first layer disposed on substrate 302 and the second set of lines 306 is housed in a second layer disposed on substrate 302, wherein the second layer is comprised of a material described in association with layers that may house the first set of lines 304. The layer used to house the second set of lines 306 may be used to form a portion of a physical grating based on the second set of lines 306. Thus, in accordance with an embodiment of the present invention, the layer used to house the second set of lines has a thickness sufficient to scatter a signal from a scatterometer. In one embodiment, the layer used to house the second set of lines has a thickness of at least 10 nanometers.

The width of each of the lines in the first set of lines 304 need not be the same as the width of the lines in the second set of lines 306. However, for illustrative purposes, these lines are treated as having substantially the same width. Referring again to FIG. 3B, in accordance with an embodiment of the present invention, the distance L between each of the lines of the first set of lines 304 and the respective corresponding lines of the second set of lines 306 is precisely one half of the distance D (the separation between the lines in each of the first set of lines 304 and the second set of lines 306), such that the second set of lines 306 is centered between the first set of lines 304. In an alternative embodiment, the distance L between each of the lines of the first set of lines 304 and the respective corresponding lines of a second set of lines 306′ is greater than half of the distance D, such that the second set of lines 306′ shifted to the right of the center of the first set of lines 304, as depicted in FIG. 3B′. In yet another embodiment, the distance L between each of the lines of the first set of lines 304 and the respective corresponding lines of a second set of lines 306″ is less than half of the distance D, such that the second set of lines 306″ shifted to the left of the center of the first set of lines 304, as depicted in FIG. 3B″.

The pitch of the first set of lines 304 may be any suitable pitch to enable the interlaying of the second set of lines 306 between the first set of lines 304. Thus, in one embodiment, the pitch of the first set of lines 304 is greater than the width of each line in the first set of lines 304 by a factor of at least 2. The pitch of the first set of lines 304 may further enable the interlaying of the second set of lines 306 between the first set of lines such that a total line spacing equal to twice the width of one line may be achieved between lines of the second set of lines 306 and lines of the first set of lines 304 (e.g. the spacing illustrated in FIGS. 3B, 3B′, and 3B″). Thus, in one embodiment, the pitch of the first set of lines 304 is greater than the width of each line in the first set of lines 304 by a factor of at least 4.

The distance L between each of the lines of the first set of lines 304 and the respective corresponding lines of a second set of lines 306 (or 306′ or 306″) may be used to determine the offset between the two masks used to provide the images of 304 and 306. In accordance with an embodiment of the present invention, the offset between two masks is determined by calculating the difference between L and a predetermined value K, where 0<K<D, where D is the separation between the lines in each of the first set of lines 304 and the second set of lines 306. The value K represents a distance of the second set of lines 306 relative to the first set of lines 304 that corresponds with optimal mask alignment between the two masks having the images of 306 and 304, respectively. The offset is then determined by comparing the actual distance of the second set of lines 306 relative to the first set of lines 304, i.e. the distance L, and then subtracting K (the calibration alignment) from L. For example, in an embodiment, optimal mask alignment is predetermined to be when the second set of lines 306 is perfectly centered in between the first set of lines 304, as depicted in FIG. 3B, i.e. K=½D. The actual mask alignment may then be determined by providing images of the first set of lines 304 and the second set of lines 306 above substrate 302 and comparing the spacing between the two sets of lines with the calibration alignment. In one embodiment, the distance L between each of the lines of the first set of lines 304 and the respective corresponding lines of the second set of lines 306 is precisely one half of the distance D, i.e. L=½D. In this case, the masks are not offset because (L−K)=(½D−½D)=0. In one embodiment, the distance L between each of the lines of the first set of lines 304 and the respective corresponding lines of the second set of lines 306 is greater than half of the distance D, i.e. L>½D. In this case, the masks are offset to the right because the difference (L−K) will yield a positive value. In one embodiment, the distance L between each of the lines of the first set of lines 304 and the respective corresponding lines of the second set of lines 306 is less than half of the distance D, i.e. L<½D. In this case, the masks are offset to the left because the difference (L−K) will yield a negative value.

In the above embodiments, the predetermined value K was selected to be ½D such that the calibration alignment corresponds with the centering of the second sets of lines 306 in between the first set of lines 304. However, it is to be understood that the calibration alignment may correspond with an off-center calibration of the second sets of lines 306 in between the first set of lines 304. Thus, in one embodiment, 0<K<½D. In another embodiment, ½<K<D.

In order to measure the distance L between each of the lines of the first set of lines 304 and the respective corresponding lines of a second set of lines 306, any suitable optical alignment technique may be used. In one embodiment, the distance L is determined based on measurements made via a technique selected from the group consisting of optical correction detection or ellipsometry. Alternatively, the images of the first set of lines 304 and the second set of lines 306 may be used to provide a physical grating in substrate 302 or in one or more layers that reside above substrate 302. Thus, in accordance with an embodiment of the present invention, a scatterometric signal may be collected for the grating comprised of lines from the first set of lines 304 and the second set of lines 306. The signal collected may then be used to determine the distance L. In one embodiment, the distance L is determined by comparing the scatterometric signal reflected from the grating comprised of lines from the first set of lines 304 and the second set of lines 306 with a calibration signal taken from a calibration grating with a spacing K (i.e. the predetermined calibration value) between two sets of lines that form the calibration grating. In a specific embodiment, each of the lines of the two sets of lines of the calibration grating are separated by the same distance D that separates each of the lines in the first set of lines 304 and the second set of lines 306. Scatterometric data from the calibration grating for comparison with the grating formed to determine the offset between the two masks having the images of the first set of lines 304 and the second set of lines 306, respectively, may be from an established set of reference signals. Alternatively, scatterometric data from the calibration grating may be collected in conjunction with the grating comprised of the first set of lines 304 and the second set of lines 306. Thus, in accordance with an embodiment of the present invention, a calibration grating is included in one of the masks used in the alignment measurement. In a specific embodiment, the mask having a test structure with the image of the first set of lines 304 also comprises a test structure with an image of a calibration grating.

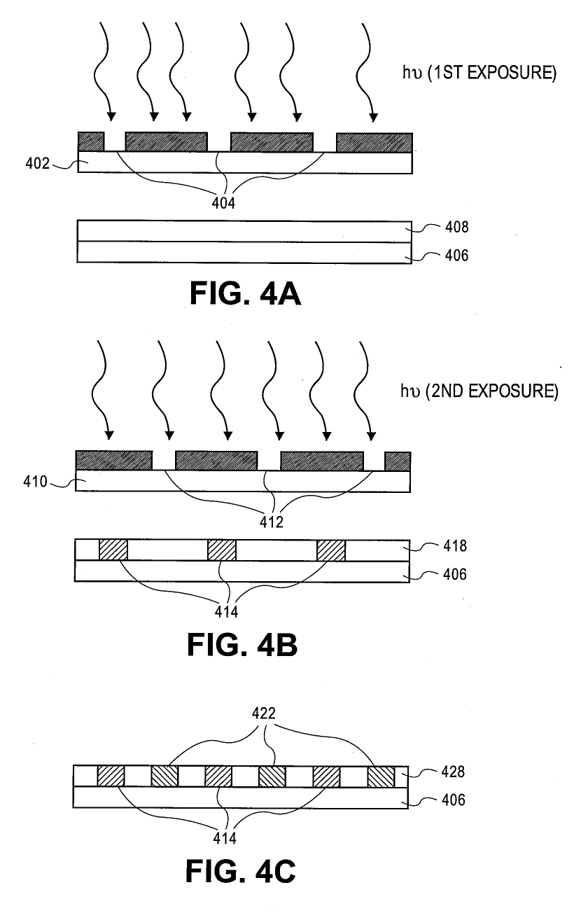

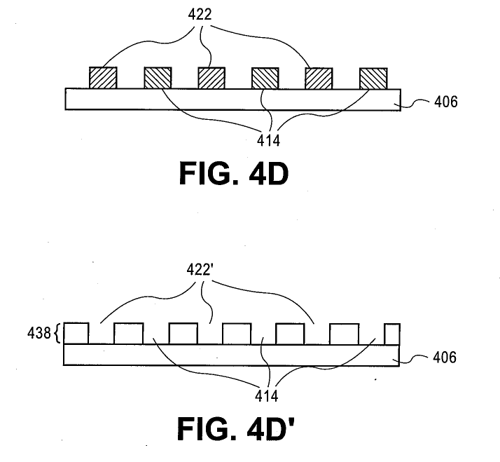

A grating may be fabricated in a photo-resist layer for use in mask alignment. FIG. 4 illustrates the cross-sectional representation of a negative exposure process for enabling a grating method of mask alignment, in accordance with an embodiment of the present invention.

Referring to FIG. 4A, an image of a first mask 402 including a first set of lines 404 patterned therein is transferred by a lithographic process (hν) to a photo-resist layer 408 above a substrate 406. Substrate 406 and photo-resist layer 408 may be comprised of any material described in association with substrate 302 and the photo-resist layers from FIG. 3. First mask 402 may be comprised of any material suitable to correspond with a selected lithographic process. For example, in accordance with an embodiment of the present invention, first mask 402 is comprised of a material selected from the group consisting of quartz, glass and transparent plastic and is used in conjunction with an optical lithographic process selected from the group consisting of 248 nm, 193 nm, 157 nm and extreme-ultra-violet (EUV) lithography. In another embodiment, first mask 402 is comprised of metal and is used in conjunction with an X-ray lithographic process. In yet another embodiment, first mask 402 is a trace and is used in conjunction with an e-beam-write lithographic process. In a specific embodiment, first mask 402 is comprised of a negative image, as depicted in FIG. 4A.

Referring to FIG. 4B, an image of a second mask 410 including a second set of lines 412 patterned therein is transferred by a lithographic process (hν) to patterned photo-resist layer 418 above substrate 406, where patterned photo-resist layer 418 already houses a first set of lines 414 transferred during the first exposure from FIG. 4A. Second mask 410 may be comprised of any material suitable to correspond with a selected lithographic process. For example, in accordance with an embodiment of the present invention, second mask 410 is comprised of a material for use in a lithographic process described in association with first mask 402. In a specific embodiment, second mask 410 is comprised of a negative image, as depicted in FIG. 4B.

Referring to FIG. 4C, a doubly-exposed photo-resist layer 428 houses first set of lines 414 and second set of lines 422, where the second set of lines 422 were transferred during the second exposure from FIG. 4B. First set of lines 414 and second set of lines 422 may have characteristics analogous to the first and second sets of lines 304 and 306, respectively, described in association with FIG. 3.

Referring to FIGS. 4D and 4D′, doubly-exposed photo-resist layer 428 is developed to provide a grating having first set of lines 414 and second set of lines 422. In accordance with an embodiment of the present invention, photo-resist layer 408 is a negative photo-resist layer and sets of lines 414 and 422 are comprised of portions of photo-resist layer 408 that were exposed during the lithographic process, as depicted in FIG. 4D. In one embodiment, photo-resist layer 408 is a negative photo-resist layer and is not developed until the images from both masks 402 and 410 have been transferred. In accordance with another embodiment of the present invention, photo-resist layer 408 is a positive photo-resist layer and sets of lines 414 and 422 are comprised of gaps between portions of photo-resist layer 408, i.e. patterned photo-resist layer 438, that were not exposed during the lithographic process, as depicted in FIG. 4D′. In one embodiment, photo-resist layer 408 is a positive photo-resist layer and is not developed until the images from both masks 402 and 410 have been transferred. In another embodiment, photo-resist layer 408 is a positive photo-resist layer and is developed after the image from mask 402 has been transferred and then is developed again subsequent to the transferring of the image from mask 410. In accordance with an embodiment of the present invention, both the developed photo-resist layer from FIG. 4D (i.e. sets of lines 414 and 422) or the developed photo-resist layer from FIG. 4D (i.e. gaps 414′ and 422′ in unexposed portion 438) can be used as a grating in a scatterometric process. In one embodiment, the gratings are used to determine the offset between masks 402 and 410 in a manner analogous to that described in association with FIG. 3.

It should be understood that the process scheme illustrated in FIG. 4 need not require double-exposure of a photo-resist layer. In accordance with another embodiment of the present invention, the image of the first mask is first transferred from a singly-exposed photo-resist layer into an etch film by an etch process. A second photo-resist layer is then deposited and the image of the second mask is transferred to the second photo-resist layer. A grating is thus formed comprising a first set of lines patterned in the etch film and a second set of lines patterned in the second photo-resist layer. In a further embodiment, the image in the second photo-resist layer is transferred to the etch film or to a second etch film to form a grating pattern. In one embodiment, the grating pattern is used to determine the offset between masks 402 and 410 in a manner analogous to that described in association with FIG. 3. In an alternative embodiment, the image from a doubly-exposed photo-resist layer is transferred to a single etch film by an etch process, the photo-resist layer is removed, and a grating is formed from the pattern of the first set of lines and the second set of lines in the single etch film. In one embodiment, the grating in the etch film is used to determine the offset between masks 402 and 410 in a manner analogous to that described in association with FIG. 3.

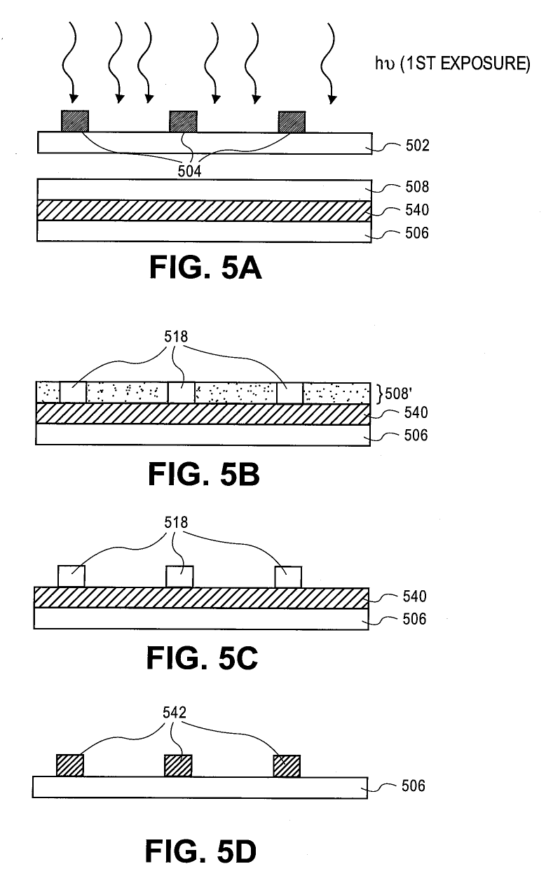

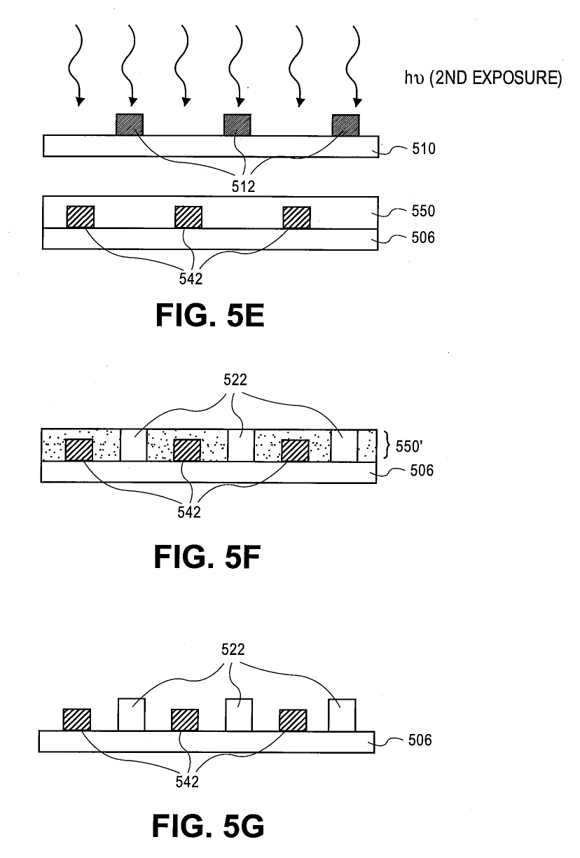

A grating may be fabricated in an etch film for use in mask alignment. FIG. 5 illustrates the cross-sectional representation of a positive exposure process for enabling a grating method of mask alignment, in accordance with an embodiment of the present invention.

Referring to FIG. 5A, an image of a first mask 502 including a first set of lines 504 patterned therein is transferred by a lithographic process (hν) to a photo-resist layer 508 above a substrate 506. An etch film 540 is in between substrate 506 and photo-resist layer 508. First mask 502, substrate 506 and photo-resist layer 508 may be comprised of any material described in association with first mask 402, substrate 406 and photo-resist layer 408 from FIG. 4. Etch film 540 may be comprised of any material described in association with the etch films from FIG. 3. The lithographic process used for the first exposure may be any lithographic process described in association with the first exposure of FIG. 4. In one embodiment, first mask 502 is comprised of a positive image, as depicted in FIG. 5A.

Referring to FIG. 5B, photo-resist layer 508 is patterned during the first exposure of FIG. 5A to form patterned photo-resist layer 508′ above etch film 540 and substrate 506. Referring to FIG. 5C, patterned photo-resist layer 508′ is developed to provide a set of lines 518 comprised of unexposed photo-resist from photo-resist layer 508. Referring to FIG. 5D, the image of the set of lines 518 is etched into etch film 540 to provide a first set of lines 542 above substrate 506 comprised of unetched material from etch film 540.

Referring to FIG. 5E, a second photo-resist layer 550 is disposed above the first set of lines 542. An image of a second mask 510 including a second set of lines 512 patterned therein is transferred by a lithographic process (hν) to second photo-resist layer 550. Second mask 510 may be comprised of any material suitable to correspond with a selected lithographic process. For example, in accordance with an embodiment of the present invention, second mask 510 is comprised of a material for use in a lithographic process described in association with first mask 502. In a specific embodiment, second mask 510 is comprised of a positive image, as depicted in FIG. 5E.

Referring to FIG. 5F, a singly-exposed photo-resist layer 550′ houses second set of lines 522. First set of lines 414 and second set of lines 422 may have characteristics analogous to the first and second sets of lines 304 and 306, respectively, described in association with FIG. 3.

Referring to FIG. 5G, singly-exposed photo-resist layer 550′ is developed to provide a grating having first set of lines 542 and second set of lines 522. In accordance with an embodiment of the present invention, photo-resist layer 508 is a positive photo-resist layer and the set of lines 522 is comprised of portions of photo-resist layer 508 that were unexposed during the lithographic process, as depicted in FIG. 5G. In one embodiment, the first set of lines 542 from etch film 540 and the second set of lines from photo-resist layer 508 combine to form a grating that is used in a scatterometric measurement. In a specific embodiment, the grating is used to determine the offset between masks 502 and 510 in a manner analogous to that described in association with FIG. 3.

It should be understood that the process scheme illustrated in FIG. 5 need not rely on a second set of lines 522 comprised of unexposed photo-resist material. In accordance with another embodiment of the present invention, the image of the second set of lines 522 is transferred to a second etch film in a second etch process. A grating is formed from the pattern of the first set of lines in the first etch film and the second set of lines in the second etch film. In one embodiment, the grating in the etch films is used to determine the offset between masks 502 and 510 in a manner analogous to that described in association with FIG. 3.

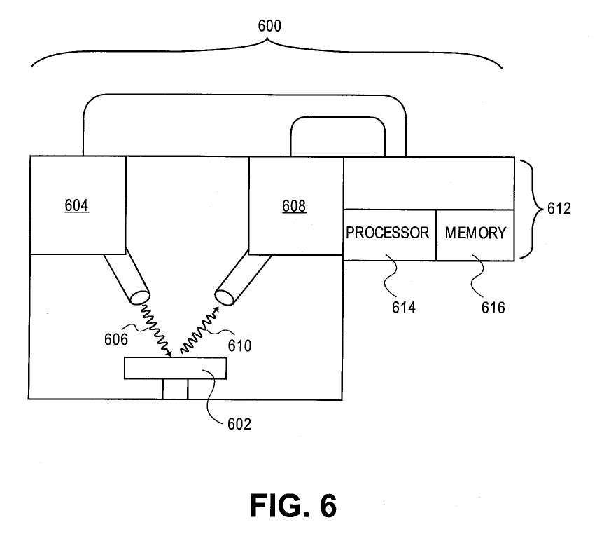

A scatterometer may be used to determine the offset of two lithographic masks be measuring the reflected signal from a grating comprised of sets of lines patterned from images on the lithographic masks. FIG. 6 illustrates a system for carrying out a grating method of mask alignment, in accordance with an embodiment of the present invention.

Referring to FIG. 6, a scatterometer 600 comprises a sample holder 602 to support a substrate having a grating patterned therein or a substrate having a grating layer patterned thereon. An input device 604 to provide an input signal 606 to a grating is aligned with the sample holder 602. A receiving device 608 to receive/detect an output signal 610 reflected from a grating is also aligned with the sample holder 602. A computing device 612 having a processor 614 and a memory 616 is coupled with the receiving device 608.

In accordance with an embodiment of the present invention, memory 616 comprises a set of instructions for comparing a test grating with a calibration grating, wherein the test grating is comprised of two or more sets of lines from two or more masks. In one embodiment, memory 616 further comprises a set of instructions for calculating the difference of a distance L and a predetermined value K, wherein L is the distance between each of the lines of a first set of lines of the grating and the respective corresponding lines of a second set of lines of the grating, wherein 0<K<D, and wherein D is the distance separating each line in the first set of lines and separating each line in the second set of lines. In a specific embodiment, the calibration grating comprises a first set of calibration lines, each calibration line separated by the distance D, and a second set of calibration lines, each calibration line separated by the distance D, and has a calibration distance equal to the predetermined value K between each of the calibration lines of the first set of calibration lines and the respective corresponding calibration lines of the second set of calibration lines. In an embodiment, the offset between two masks is calculated by comparing the test grating with a calibration grating in a manner analogous to that described in association with FIG. 3. In one embodiment, an alignment change on an exposure tool, such as a stepper, is made between a first and a second mask in response to the offset determined by using the scatterometer 600.

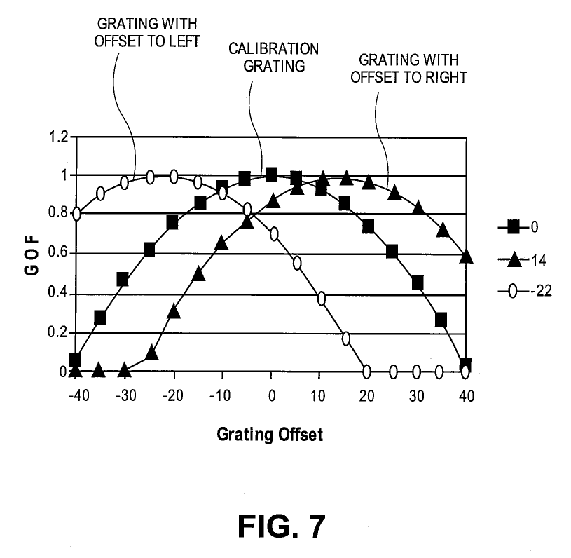

The offset between two lithographic masks may be determined by comparing scatterometric measurement taken from a test grating with that taken for a calibration grating. For example, FIG. 7 illustrates a plot of Grating Offset versus Goodness of Fit (GOF) of offset gratings compared with a calibration grating, in accordance with an embodiment of the present invention. The maximum GOF for the data represented by open ovals is at a grating offset of −22 units. That is, the grating is comprised of a first set of lines and a second set of lines, wherein the second set of lines was provided from an image of a second mask that is offset to the left of a first mask, as determined respective to a calibration grating (closed squares) set at 0 offset. The maximum GOF for the data represented by closed triangles is at a grating offset of +14 units. That is, the grating is comprised of a first set of lines and a second set of lines, wherein the second set of lines was provided from an image of a second mask that is offset to the right of a first mask, as determined respective to a calibration grating (closed squares) set at 0 offset. Thus, in accordance with an embodiment of the present invention, the offset between two masks can be determined experimentally by comparing a test grating with a calibration grating.

It is to be understood that the present invention is not limited to the formation of only one test grating structure. In accordance with an embodiment of the present invention, a second set of lines is included on each mask for calibration. A second grating is formed wherein the lines of the second grating are perpendicular to the lines of the first grating used to determine the offset in one direction between two masks. Thus, in one embodiment, both the horizontal and the vertical offsets between two masks are determined by forming two orthogonal test grating structures. It is also to be understood that the calibration grating included in one of the masks is not limited to a calibration grating that represents perfect mask alignment. In accordance with another embodiment of the present invention, an image of a calibration grating is included on one of the masks, wherein the calibration grating represents an offset between the two masks. Thus, in one embodiment, the offset measured between two masks can be internally verified against a calibration grating that represents a given offset in addition to a calibration grating that represents perfect mask alignment.

Thus, a method and test-structure for determining an offset between lithographic masks have been disclosed. In one embodiment, an image of a first mask is provided in a patterning layer on a substrate. The image of the first mask comprises a first set of lines, each line separated by a distance D. An image of a second mask is then provided in the patterning layer. The image of the second mask comprises a second set of lines, each line also separated by the distance D. The second set of lines interlays the first set of lines to form a grating with a distance L between each of the lines of the first set of lines and the respective corresponding lines of the second set of lines. The offset between the first and second masks is determined by calculating the difference between the distance L and a predetermined value K, where 0<K<D. In a specific embodiment, K=½D.

What is claimed is:

1. A method for determining an offset between a first mask and a second mask, comprising:
providing an image of said first mask in a patterning layer on a substrate, wherein said image of said first mask comprises a first set of lines, each line separated by a distance D;
providing an image of said second mask in said patterning layer, wherein said image of said second mask comprises a second set of lines, each line separated by said distance D, and wherein said second set of lines interlays said first set of lines to form a grating with a distance L between each of the lines of said first set of lines and the respective corresponding lines of said second set of lines; and
calculating the difference of said distance L and a predetermined value K, wherein 0<K<D.

2. The method of claim 1 wherein K=½D.

3. The method of claim 1 wherein the pitch of said first set of lines is greater than the width of each line of said first set of lines by a factor of at least 2.

4. The method of claim 1 wherein calculating the difference between said distance L and said predetermined value K comprises using a scatterometer to measure a signal reflected from said grating.

5. The method of claim 4 wherein said signal reflected from said grating is compared with a calibration signal, wherein said calibration signal is obtained from a calibration grating comprising a first set of calibration lines, each calibration line separated by said distance D, and a second set of calibration lines, each calibration line separated by said distance D, and having a calibration distance equal to said predetermined value K between each of the calibration lines of the first set of calibration lines and the respective corresponding calibration lines of the second set of calibration lines.

6. The method of claim 5 wherein said calibration grating is included in said first mask.

7. The method of claim 1 wherein said images of said first and second masks are negative images, and wherein said patterning layer is a positive photo-resist layer.

8. The method of claim 7 wherein said positive photo-resist layer is developed subsequent to providing said image of said first mask, but prior to providing said image of said second mask, in said positive photo-resist layer, and wherein said positive photo-resist layer is developed again subsequent to providing said image of said second mask in said positive photo-resist layer.

9. The method of claim 1 wherein said images of said first and second masks are negative images, wherein said patterning layer is a negative photo-resist layer, and wherein said negative photo-resist layer is not developed until after said image of said second mask is provided in said negative photo-resist layer.

10. The method of claim 1 wherein, subsequent to providing said image of said second mask in said patterning layer, said images of said first and second masks in said patterning layer are transferred to an etch film between said patterning layer and said substrate and said patterning layer is then removed, and wherein calculating the difference of said distance L and said predetermined value K comprises measuring a signal reflected from an image of said grating in said etch film.

11. The method of claim 1, further comprising:
determining a second offset between said first mask and said second mask, wherein said second offset is perpendicular to said offset.

12. A method for determining an offset between a first mask and a second mask, comprising:
providing an image of said first mask in a patterning layer on a substrate to form a patterned layer, wherein said image of said first mask comprises a first set of lines separated by a distance D;
depositing a photo-resist layer over said patterned layer;
providing an image of said second mask in said photo-resist layer, wherein said image of said second mask comprises a second set of lines separated by said distance D, and wherein said second set of lines interlays said first set of lines to form a grating with a distance L between each of the lines of said first set of lines and the respective corresponding lines of said second set of lines; and
calculating the difference of said distance L and a predetermined value K, wherein 0<K<D.

13. The method of claim 12 wherein K=½D.

14. The method of claim 12 wherein the pitch of said first set of lines is greater than the width of each line of said first set of lines by a factor of at least 2.

15. The method of claim 12 wherein calculating the difference between said distance L and said predetermined value K comprises using a scatterometer to measure a signal reflected from said grating.

16. The method of claim 15 wherein said signal reflected from said grating is compared with a calibration signal, wherein said calibration signal is obtained from a calibration grating comprising a first set of calibration lines, each calibration line separated by said distance D, and a second set of calibration lines, each calibration line separated by said distance D, and having a calibration distance equal to said predetermined value K between each of the calibration lines of the first set of calibration lines and the respective corresponding calibration lines of the second set of calibration lines.

17. The method of claim 16 wherein said calibration grating is included in said first mask.

18. A system for determining an offset between a first mask and a second mask, comprising:
a sample holder to support a substrate having a layer with a grating patterned therein;
a scatterometer to provide an input signal directed to said grating and to detect an output signal reflected from said grating; and
a computing device having a processor and a memory, wherein said memory comprises a set of instructions for comparing said grating with a calibration grating.

19. The system of claim 18 wherein said memory further comprises a set of instructions for calculating the difference of a distance L and a predetermined value K, wherein L is the distance between each of the lines of a first set of lines of said grating and the respective corresponding lines of a second set of lines of said grating, wherein 0<K<D, and wherein D is the distance separating each line in said first set of lines and separating each line in said second set of lines.

20. The system of claim 19 wherein said calibration grating comprises a first set of calibration lines, each calibration line separated by said distance D, and a second set of calibration lines, each calibration line separated by said distance D, and has a calibration distance equal to said predetermined value K between each of the calibration lines of the first set of calibration lines and the respective corresponding calibration lines of the second set of calibration lines.

21. A test structure for determining an offset between a first mask and a second mask, comprising:
a calibration grating having a first set of lines, each line separated by a distance D, and a second set of lines, each line separated by said distance D, wherein said second set of lines interlays said first set of lines with a distance K between each of the lines of said first set of lines and the respective corresponding lines of said second set of lines, and wherein 0<K<D.

22. The test structure of claim 21 wherein K=½D.

23. The test structure of claim 21 wherein K<½D.

24. The test structure of claim 21 wherein K>½D.
